(19) United States
(12) Patent Application Publication
(10) Pub. No.: US 2024/0405535 A1
(43) Pub. Date: Dec. 5, 2024

(54) MODULAR ELECTRIC CHARGING APPARATUS WITH RECONFIGURABLE TOP

(71) Applicant: Andrew Molle, Irvine, CA (US)

(72) Inventor: Andrew Molle, Irvine, CA (US)

(21) Appl. No.: 18/204,547

(22) Filed: Jun. 1, 2023

(51) Int. Cl. H02G 9/06; B60L 53/31; H02G 3/04

(52) U.S. Cl. CPC H02G 9/06; B60L 53/31; H02G 3/0418; H02G 3/0437

(57) ABSTRACT

An energy infrastructure system comprising a raceway with first and second rails or other rows of multiple connection points, first and second cover plates positionally affixed with respect to the first and second rails, a buss extending along at least a portion of the raceway, a first and second current carrying structure electrically coupled to the buss, where each is configured to carry electrical current through a passageway in a cover plate. A method for updating an electrical infrastructure system, comprising affixing a second distribution hub to the second cover plate, coupling the second distribution hub to draw power from the buss, and moving or replacing the first cover plate with a third second cover plate, such that the third cover plate occupies a different position or length along the raceway.

### FIELD OF THE INVENTION

The field of the invention is an energy infrastructure system. More particularly, the present energy infrastructure system creates a versatile and upgradable charging and connection platform that can be used with a variety of different providers of vehicle charging systems, battery storage systems, back-up generation systems, and utility grid systems.

### BACKGROUND

The background description includes information that may be useful in understanding the present invention. It is not an admission that any of the information provided herein is prior art or relevant to the presently claimed invention, or that any publication specifically or implicitly referenced is prior art.

Electric vehicles are becoming increasingly popular, and the need to charge different types of vehicles at different locations continues to increase. The development of the charging stations typically involves a bespoke planning and construction processes at locations or facilities where a person may park their vehicle for an extended period of time. As the number of vehicles that will be charged increases, the charging stations need to accommodate more and more vehicles with varying charging capabilities. The charging and updating of the different vehicles and charging connectors will also need accommodate the expansion of the industry, along with updates to standalone vehicular charging system hardware. Most vehicle charging stations are manufactured and are permanently installed with a finite number of stations and any upgrades or expansion requires removal of the entire previous system. This can make the charging stations unavailable for a prolonged period while the construction is being performed. A number of patents and or publications have been made issued that address different aspects of the problems. Exemplary examples of patents and or publication that attempt to address this/these problem(s) are identified and discussed below.

U.S. Pat. No. 5,538,361 issued on Jul. 23, 1996 to John V. Beamer and is titled Apparatus for Forming a Trench. This patent discloses a system for forming a single-walled trench comprising a pair of frame members, each having a horizontal section and a section depending from the horizontal section; a collapsing pair of wall pans having sidewalls interior to the depending portion of the frame members, a bottom floor disposed between the sidewalls, a releasing mechanism to collapse inward the sidewalls. While this patent discloses a trench form it does not provide support for internal power transmission.

U.S. Pat. No. 4,145,857 issued on Mar. 27, 1979 to Benjamin L. Tilsen and is titled Base for Mounting Electrical Equipment. This patent discloses a sectionalized structure of preformed wall panels especially adapted for use as base for burial in the earth for mounting above-ground electrical equipment such as sectionalizing cabinets, transformers, electrical switch gear boxes, and similar equipment connected to underground utility cables. This patent seems to merely describe an open cavity without any structure for power transmission out of the cavity. U.S. Pat. No. 262,630 issued on Aug. 15, 1882 to T. N. Vail and is titled Subterranean System of Electrical Conductors. This patent discloses underground wires for electrical systems of communication and improved methods of laying them. This patent is not for power transmission lines and further does not contain buss wiring where connections can be made along the length of the buss wire or strip.

U.S. Pat. No. 343,458 issued on Jun. 8, 1886 to G. S. Hull and is titled Underground Conduit for Electrical Conductors. The object of this invention is to prevent the loss of conductivity which results from the breaking of electrical conductors in test boxes and provides test pins to test the condition of each conductor. This patent does not provide buss wiring or strips to connect electrical power for a charging system. U.S. Pat. No. 11,159,033 issued on Oct. 26, 2021 to A. Molle further describes a modular electric charging apparatus providing a universal base system that can be used to install an electrical power system, with electrical distribution hubs provided from different manufacturers to be connected by electrical wiring into their unique hubs. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

Thus, there remains a need for improved an energy infrastructure system that can be easily upgraded, expanded, and can accommodate different distribution hubs and vehicles.

### SUMMARY OF THE INVENTION

The inventive subject matter provides apparatus, systems, and methods in which an energy infrastructure system comprises a raceway with first and second rails, first and second cover plates positionally affixed with respect to the first and second rails, a buss extending along at least a portion of the raceway, and a first and second current carrying structure electrically coupled to the buss, where each is configured to carry electrical current through a passageway in a cover plate. A method for updating an electrical infrastructure system is also described, comprising affixing a second distribution hub to the second cover plate, coupling the second distribution hub to draw power from the buss, and replacing the first cover plate with the second cover plate, such that the second cover plate extends along the raceway for a different length than the first cover plate.

It is an object of the energy infrastructure system to provide a universal base system that can be used to install electrical power. The universal base allows for cabinets (or electrical distribution hubs) from different manufacturers to connect electrical wiring into their unique cabinet. The cabinet can then connect into a conduit system for distribution to a plurality of vehicle charging locations for distribution. The universal base can have a variety of securing mounts to accommodate different size and shape cabinets and locations for power cable routing into the cabinets as needed for the manufacturer, electrical code and building code.

It is an object of the energy infrastructure system to have an open frame structure for setting and casting concrete around the open frame. The open frame is set level with the desired finished surface with a trench canal and the concrete can be poured into both sides of the cable trench form frame. The open nature of the cable trench form frame allows the concrete to flow around the frame and also sets the frame in the concrete. There is no removal of the frame after the concrete sets and frame is a permanent part of the structure. The frame can further include mounting locations and apparatus that can extend into the poured concrete to provide structural security to above surface mounted housings.

It is another object of the energy infrastructure system to include a support frame and canal that extends from the cabinet base. The canal is easily cut to length or multiple canals can be placed in series for extending the length. This allows for future expansion and room for additional charging stations to be added at the future. The length of the canal can also be extended at a future time without effecting the operation of installed charging stations. An insulated spacer is installed into the support frame to ensure that the canal maintains its shape and provides an electrical connection support system.

It is still another object of the modular energy infrastructure system to include a plurality of buss bar contacts. The buss bars set and/or buss cables and are secured in the insulated spacer. The buss bars extend the length of the canal and provide electrical connection at any point along the length of the canal. This also allows an installer to place a second charging connection to allow vehicles on both sides of the canal. The buss bars can also be extended in the future to provide connections for additional charging stations. The cross-section of the buss bars can also be sized, increased or changed based upon the amount of power that is being used to charge vehicles.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a perspective view of an energy infrastructure, which comprises a raceway, two electrical distribution hubs supported by individual cover plates, and a post.

FIG. 1B is an alternative, side view of the energy infrastructure, with an electrical distribution hub positioned beneath a cover plate.

FIG. 2 depicts a perspective view of an energy infrastructure, which comprises a raceway, and an electrical distribution hub supported by multiple cover plates.

FIG. 3 is a perspective view of an alternative energy infrastructure having a electrical distribution hub supported by an individual cover plate, another electrical distribution hub supported by multiple cover plates, and a spacer cover plate.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

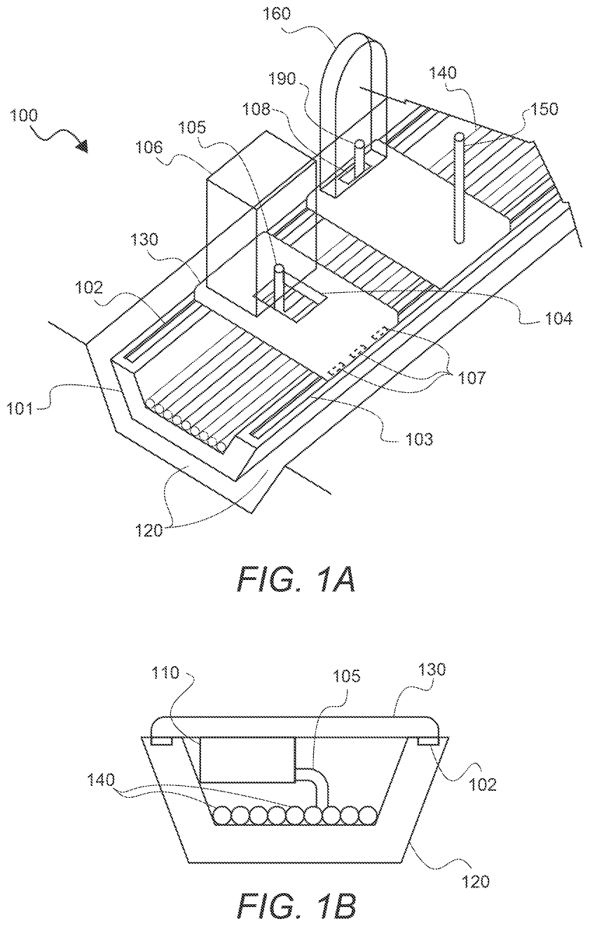

FIG. 1A shows a perspective view of an energy infrastructure 100, which comprises a raceway 101 having electrical distribution hubs 105 and 160 supported by cover plates 130 and 170, respectively, and positionally affixed with respect to first rail 102 and a second rail 103. Raceway 101 is at least partially positioned within a trench 120, and further includes a buss 140 extending along at least a portion of raceway 101.

Cover plate 130 is removably coupled with first rail 102 and second rail 103 via fasteners 107. In a related embodiment, cover plate 130 has a thickness of at least 5 mm. Cover plate 130 comprises at least one of steel, concrete, and a resin composite. Cover plate 130 includes a passageway 104, where current carrying structure 105 carries electrical current through the passageway 104 in cover plate 130. Cover plate 130 is removably coupled with first rail 102 and second rail 103 via fasteners 107. In a preferred embodiment, fasteners 107 are a clip. In a related embodiment, fastener 107 is a bolt. In other embodiments, fastener 107 is an adhesive.

In a preferred embodiment, current carrying structure 105 is configured to provide electrical current to an electrical distribution hub 106 from the buss 140. In the depicted embodiment, the passageway 104 of cover plate 130 is sized and dimensioned to at least partially extend beyond the footprint of electrical distribution hub 105. Cover plate 170 is also removably coupled with first rail 102 and second rail 103 via fasteners 171. Cover plate 170 includes a passageway 104, where current carrying structure 110 carries electrical current through the passageway 108 in cover plate 170. Cover plate 170 further includes a post 150 positionally affixed with respect to the cover plate 170. Advantageously, post 150 is positioned to obstruct electrical distribution hub 160 from vehicular incursion on or over cover plate 170. In a preferred embodiment, cover plate 130 and cover plate 170 occupy different lengths along first rail 102 and a second rail 103, respectively. It is further contemplated that both the cover plate 130 and cover plate 170 are slidable along the first rail 102 and a second rail 103.

Passageway 108 is sized and dimensioned to at least partially extend beyond the footprint of electrical distribution hub 105. In a preferred embodiment, current carrying structure 110 is configured to provide electrical current to an electrical distribution hub 160 from the buss 140. In a related embodiment, the electrical distribution hub 160 is different than the electrical distribution hub 106 by a width, length, height, or weight rating. In another embodiment, the electrical distribution hub 160 is a different model than the electrical distribution hub 106. In a related embodiment, the energy infrastructure 105 has a weight preferably between 300 kg and 1000 kg and even up to 5000 kg. In a preferred embodiment, current carrying structure 105 comprises a metal containing bar.

FIG. 1B shows a side view of energy infrastructure 100, which comprises a raceway 101 having a first rail 102, a second rail 103, and an electrical distribution hub 180 positioned below a cover plate 190 and positionally affixed with respect to first rail 102 and a second rail 103. Cover plate 190 includes a passageway 195, where current carrying structure 185 carries electrical current through the passageway 195 in cover plate 190. Cover plate 190 is removably coupled with first rail 102 and second rail 103 via fasteners (not shown). In a preferred embodiment, electrical distribution hub 180 is positioned such that at least some of a weight of the hub 180 is supported by first cover plate 190.

Cover plate 190 is removably coupled with first rail 102 and second rail 103 via fasteners (not shown). In a preferred embodiment, electrical distribution hub 180 is positioned such that at least some of a weight of the hub 180 is supported by cover plate 190. In a related embodiment, electrical distribution hub 180 is cantilevered with respect to cover plate 190.

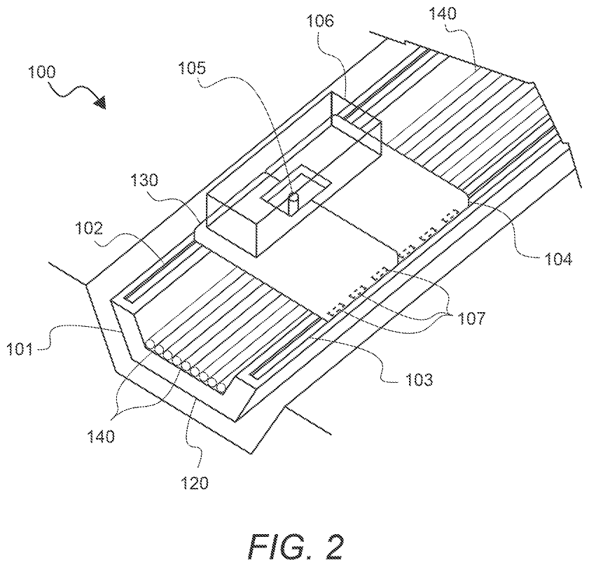

FIG. 2 shows an alternative embodiment of energy infrastructure 100, which comprises a raceway 101 having a first rail 102, a second rail 103, and an electrical distribution hub 177 positioned above cover plates 135 and 175. Cover plates 135 and 175 are positionally affixed with respect to first rail 102 and a second rail 103, and are removably coupled via fasteners 107. Cover plates 135 and 175 further include a shared passageway 176, where current carrying structure 105 carries electrical current through the passageway 176 to electrical distribution hub 177.

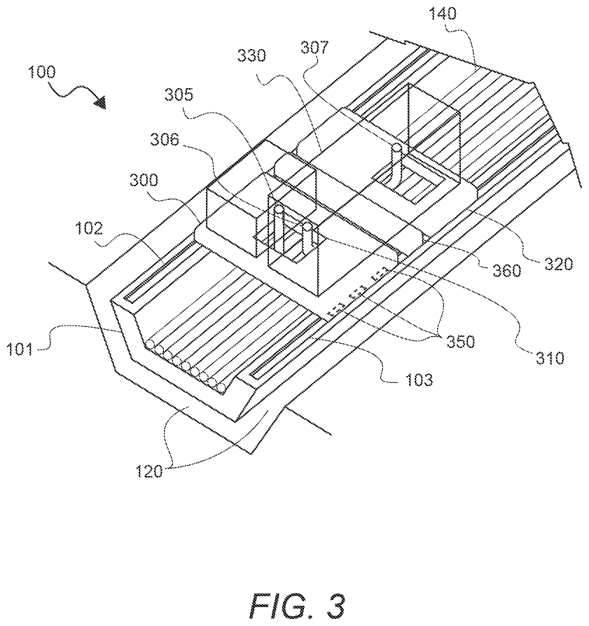

FIG. 3 depicts another embodiment of energy infrastructure 100, which comprises a raceway 101 having electrical distribution hub 305 supported by cover plate 300, and electrical distribution hub 330 supported by cover plate 300 and 320. Raceway 101 further includes a spacer cover plate 310, disposed between cover plate 300 and cover plate 320. Cover plate 300 includes a passageway 310, where current carrying structures 305 and 306 carry electrical current through the passageway 310 in cover plate 300.

Cover plate 300 is affixed to and extends along the raceway 101 for a first length, where electrical distribution hub 310 affixed to cover plate 300 and configured to draw power from the buss 120 via current carrying structure 305. Electrical distribution hub 330 is affixed to cover plates 320 and 300, and coupled to the electrical distribution hub 330 to draw power from the buss 140 via current carrying structures 306 and 307, respectively. In a preferred embodiment, cover plate 320 replaces cover plate 300, such that the cover plate 320 extends along the raceway 101 for a second length different from the first length.

In the depicted embodiment, the cover plate 320 is shorter than the cover plate 300, and spacer cover plate 360 is installed in the raceway 101 to make up for a difference in length between the cover plates 320 and 300. In preferred embodiments, size of cover plate 320 is adjusted to accommodate a change in width of a parking space for a vehicle. In some embodiments, electrical distribution hub 305 is a different model from electrical distribution hub 330.

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

Additional Contemplated claims
20. An energy infrastructure comprising:
   a series of potential connection points;
   first and second cover plates configured to be removably positioned along the series of potential connection points;
   a buss extending along a raceway;
   a first current carrying structure electrically coupled to the buss, and configured to carry electrical current through a first passageway in the first cover plate; and
   a second current carrying structure electrically coupled to the buss, and configured to carry electrical current through a second passageway in the second cover plate.
21. The energy infrastructure of claim 20, wherein the raceway is at least partially positioned within a trench.
22. The energy infrastructure of claim 20, wherein the first and second cover plates are configured to be removably positioned along the series of potential connection points using at least one of a clip and a bolt.
23. The energy infrastructure of claim 20, further comprising a first electrical distribution hub configured to communicate power with the first current carrying structure, the first electrical distribution hub positioned such that at least some of a weight of the electrical distribution hub is supported by the first cover plate.
24. The energy infrastructure of claim 23, where first electrical distribution hub is positioned above the first cover plate.
25. The energy infrastructure of claim 23, where first electrical distribution hub is positioned below the first cover plate.
26. The energy infrastructure of claim 4, where first electrical distribution hub is cantilevered with respect to the first cover plate.
27. The energy infrastructure of claim 20, further comprising first and second electrical distribution hubs supported by the first and second cover plates, respectively, and wherein the first electrical distribution hub has a different design from the second electrical distribution hub.
28. The energy infrastructure of claim 20, further comprising a first electrical distribution hub configured to receive power from the first current carrying structure, the first electrical distribution hub having a weight of between 300 kg and 1000 kg.
29. The energy infrastructure of claim 20, wherein the first cover plate has a different weight rating than the second cover plate.
30. The energy infrastructure of claim 20, wherein the buss comprises a metal containing bar.
31. The energy infrastructure of claim 20, wherein the first and second cover plates occupy different lengths along the series of potential connection points.
32. The energy infrastructure of claim 20, further comprising a post positionally affixed with respect to the first cover plate.
33. The energy infrastructure of claim 20, further comprising a spacer cover plate not passing current from the buss.
34. The energy infrastructure of claim 20, wherein the series of potential connection points comprise continuous positions along a rail.
35. A method for updating an electrical distribution system having electric current distribution line positioned within a raceway, the method comprising:
   affixing a first cover plate to a first position relative to the raceway, and a first distribution hub to the first cover plate,
   affixing a second cover plate to a second position relative to the raceway, and a second distribution hub to the second cover plate,
   configuring the first and second distribution hubs to receive from or provide power to the current distribution line; and
   moving the first cover plate to a third position relative to the raceway, wherein the third position is different from the first position.
36. The method of claim 35, further comprising first and second rails, and wherein the step of moving the first cover plate comprises sliding the first cover plate along the first and second rails.
37. The method of claim 35, further comprising placing a spacer cover plate between the first and second rails following moving of the first cover plate.
38. A method for updating an electrical distribution system having electric current distribution line positioned within a raceway, the method comprising:
   affixing first and second cover plates relative to the raceway;
   affixing first and second distribution hubs to the first and second cover plates, respectively; and
   replacing the first cover plate with a third cover plate having a different length along the raceway than the first cover plate.
39. The method of claim 38, further comprising placing a spacer cover plate between the second rails and third cover plates.
40. The method of claim 38, wherein the first and third cover plates occupy different lengths along the raceway, and further comprising selecting the length of the third plate to accommodate a change in width of a parking space for a motor vehicle.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. An energy infrastructure comprising:
a raceway with first and second rails;
at least first and second cover plates positionally affixed with respect to the first and second rails;
a bus extending along at least a portion of the raceway;
a first current carrying structure electrically coupled to the bus, and configured to carry electrical current through a first passageway in the first cover plate; and
a second current carrying structure electrically coupled to the bus, and configured to carry electrical current through a second passageway in the second cover plate.

2. The energy infrastructure of claim 1, wherein the raceway is at least partially positioned within a trench.

3. The energy infrastructure of claim 1, further comprising at least one of a clip and a bolt removably coupling the first cover plate with the first rail.

4. The energy infrastructure of claim 1, further comprising a first electrical distribution hub configured to receive power from the first current carrying structure, the first electrical distribution hub positioned such that at least some of a weight of the electrical distribution hub is supported by the first cover plate.

5. The energy infrastructure of claim 4, where first electrical distribution hub is positioned above the first cover plate.

6. The energy infrastructure of claim 4, where first electrical distribution hub is positioned below the first cover plate.

7. The energy infrastructure of claim 4, where first electrical distribution hub is cantilevered with respect to the first cover plate.

8. The energy infrastructure of claim 1, further comprising first electrical distribution hubs supported by the first and second cover plates, respectively, and wherein the first electrical distribution hub is a different design from the second electrical distribution hub.

9. The energy infrastructure of claim 1, further comprising a first electrical distribution hub configured to receive power from the first current carrying structure, the first electrical distribution hub having a weight of between 300 kg and 1000 kg.

10. The energy infrastructure of claim 1, wherein the first over plate has a thickness of at least 5 mm.

11. The energy infrastructure of claim 1, wherein the first cover plate comprises at least one of steel, concrete, and a resin composite.

12. The energy infrastructure of claim 1, wherein the first cover plate has a different weight rating than the second cover plate.

13. The energy infrastructure of claim 1, wherein the first current carrying structure comprises a metal containing bar.

14. The energy infrastructure of claim 1, wherein the first and second cover plates occupy different lengths along the first and second rails.

15. The energy infrastructure of claim 1, further comprising a post positionally affixed with respect to the first cover plate.

16. The energy infrastructure of claim 1, further comprising a spacer cover plate not passing current from the bus.

17. A method for updating a raceway infrastructure having: (a) each of at least first and second cover plates positionally affixed to both first and second rails of the raceway; and (b) an electrical bus extending along at least a first section of the raceway; method comprising:
uncoupling the first and second cover plates from the first and second rails;
removing at least the first and second cover plates from the raceway;
affixing third and fourth cover plates to the first and second rails; and
coupling a power cable to the bus and a distribution hub, and passing the power cable through the first cover plate;
wherein a combined length of the first and second cover plates along the raceway is different from a combined length of the third and fourth cover plates along the raceway.

18. The method of claim 17, wherein the first and second cover plates have different lengths along the raceway.

19. The method of claim 17, wherein the third plate positionally replaces the first plate, and the fourth plate is located is a position along the raceway that was not occupied by the second plate.

20. The method of claim 17, wherein there is no second power cable passing through the second plate.
